(19) United States
(12) Patent Application Publication
(10) Pub. No.: US 2007/0221749 A1
(43) Pub. Date: Sep. 27, 2007

(54) Heated saltwater highway deicing machine

(76) Inventor: Leon Edward Zaharis, Ithaca, NY (US)

Correspondence Address: LEON EDWARD ZAHARIS, 1398 MECKLENBURG RD., ITHACA, NY, 14850-9389, US

(21) Appl. No.: 11/435,641

(22) Filed: May 17, 2006

Related U.S. Application Data
(60) Provisional application No. 60/785,934, filed on Mar. 24, 2006.

(51) Int. Cl. B05B 1/20; B05B 9/03

(52) U.S. Cl. 239/159; 239/146

(57) ABSTRACT

My invention is different in that it uses high temperature water to dissolve pure evaporated salt blocks to create a highly saturated salt brine to provide highway deicing and snow control. with less salt used for deicing and snow removal using ordinary plain molasses may also be added to the salt brine to enhance its ability to stick on the road. Rock salt is not pure salt as it contains impurities that are inherent in its composition which give it its grey color and has pieces of rock in it from the mining process. Rock salt is also temperature dependent as it does not work very well below freezing temperatures with out calcium chloride or magnesium chloride additives. The heated salt brine will be able to melt ice and snow quickly and stay in place to continue its deicing with the molasses and will not drift away due to the use of the spray curtain.

### CROSS-REFERENCE TO RELATED APPLICATIONS

Not applicable.

### BACKROUND

1. Field of Invention

This application is entitled to the benefit of Provisional patent application Ser. No. 11/435,641 filed May 17, 2006.

This invention deals specifically with improving deicing and snow removal on highways, bridges, roads and streets.

2. Prior Art

Several million tons of deep mined rock salt is used for highway deicing which requires massive amounts of diesel fuel to deliver rock salt by rail or truck and much more diesel fuel, labor, and equipment cost for loading stockpiles, reloading trucks for delivery to the end user, stock piling at the end users location, loading salt spreaders and actual deicing done by highway plowing crews.

Dry rock salt is removed from a local highway departments stockpile dumped into salt and sand spreaders by front end loaders or by gravity silos.

The salt spreader-plow truck is driven to the location where deicing is needed and deicing is done as the road is plowed when needed by spreading the rock salt on the road from the rear of the plow truck as the truck drives from point a to b. when the truck is empty or done spreading salt on its designated route the truck driver returns to the highway department for reloading for the next days plowing.

This process using deep mined rock salt wastes huge amounts of diesel fuel, labor and equipment resources due to poor use of available resources for highway deicing and additional costs from rock salt price hikes during the salt season which is from September first to May first during the calender year.

My invention will reduce the amount of salt used for deicing and snow control significantly by reducing rock salt purchases and related expenses equipment costs and repairs for ice and snow removal equipment.

Sodium chloride levels have increased significantly in some areas where ground water used for human consumption due to over use of rock salt to remove snow and ice from rural roads.

The use of a high saline saturated brine used at a warm temperature with or without molasses or magnesium chloride can be used at a lower delivery rate with the heated pure salt Solution reducing the potential damage to the local environment.

This in turn will reduce pollution of ground water and surface waters from salt used for deicing roads bridges and highways and reduce the fuel, labor and related equipment costs needed for highway deicing.

### SUMMARY

Sea water is one percent salt and seawater will not freeze. An excellent example of proof is when a highly saturated salt brine is used to make block ice out of sweet water/potable water in stainless steel molds for the standard two hundred pound block of ice. The highly saturated brine acts as a cooling medium to freeze the potable water in the block ice molds.

The use of heated water to dissolve pure evaporated salt and spraying the hot saltwater solution with or without adjuncts such as molasses which is naturally sticky to the touch, molasses salt blocks or magnesium chloride will increase common evaporated salts ice and snow melting ability due to its chemical composition and reduce the amount of sodium chloride needed for deicing roadways as the common molasses will not melt away thereby retaining the solution in place to melt the snow and ice.

### OBJECTS AND ADVANTAGES

Accordingly, besides the reduction in rock salt use as described in my above patent, several objects and advantages are:
(a) To reduce labor costs and overtime expenses.
(b) To reduce vehicle repair and change over costs from season to season.
(c) To reduce total miles driven by snow plows.
(d) To reduce snow removal vehicle maintenance during the winter season.
(e) To increase the useful life of highway maintenance vehicles by reducing milage driven.
(f) To reduce tire costs by reducing miles driven.
(g) To reduce air pollution from diesel exhaust.
(h) To eliminate the need for a front end loader to fill salt spreaders and use a small less expensive fork lift to move pallets of salt blocks to the deicing unit.
(i) To reduce year round salt inventories and the necessity for environmentally safe salt storage and salt pollution at stockyards of highway materials.
(j) To reduce expenditures for salt for deicing used for deicing streets, roads, bridges and highways.
(k) To reduce the local taxpayers burden for purchase of road salt.
(l) To reduce salt runoff into our freshwater streams, lakes, and rivers and related sodium chloride levels in ground water which is common with shallow water wells or old wells near a road or highway.
(m) To reduce the damage done to steel bridges, concrete bridge abutments, and concrete bridge decks by over use of salt.
(n) To reduce the need for repair of steel bridges.
(o) To make it easier to pre salt the roads before storms and know it will not be wasted by overdosing the roadway or spreading too much at one time.
(p) To reduce the salt being overshot to the side of the roadway past the drainage ditch as this is salt that is lost forever for deicing use and eventually will wash away and dissolve in to surface water run off or flow into the ground water reservoirs.

### THE DRAWING

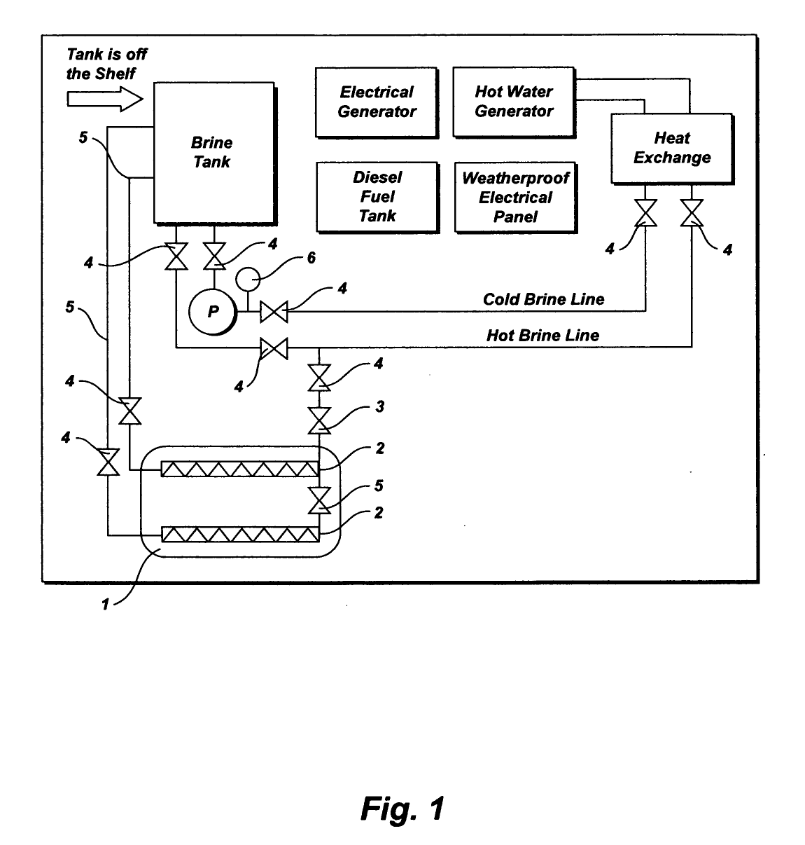

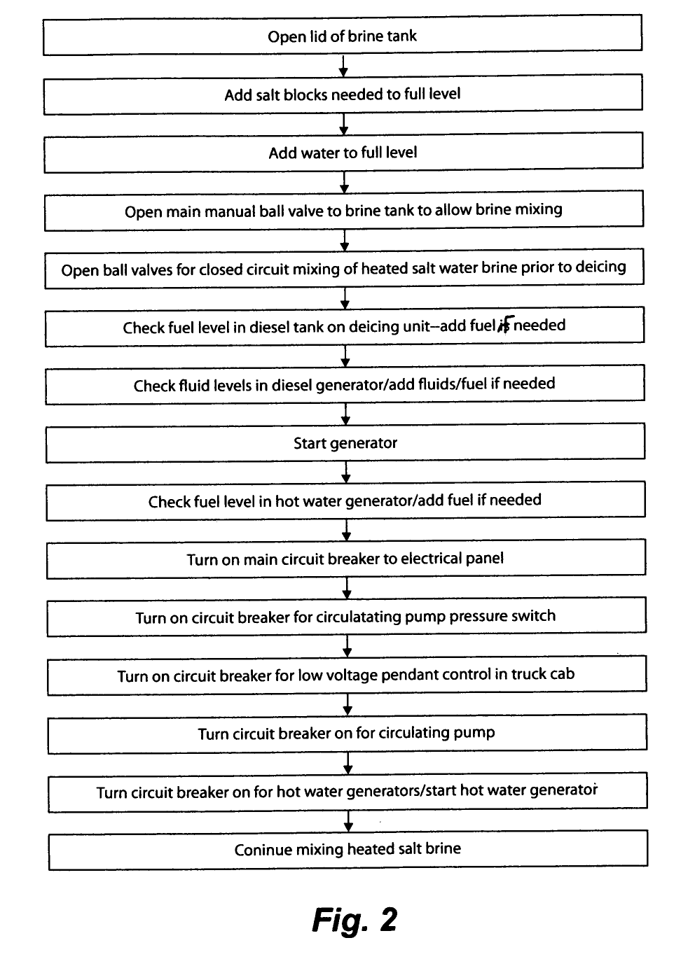

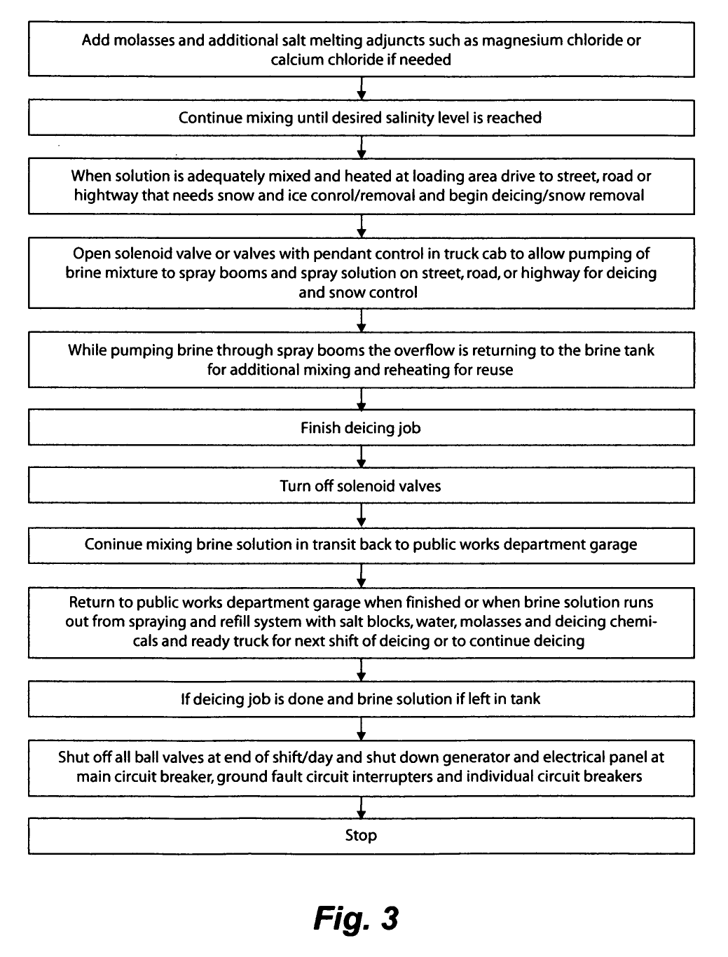

The drawing in FIG. 1 sheet 1/1 is shown from a top view for clarity fully illustrating the components and flow of the heated salt brine delivery system.

### REFERENCE NUMERALS IN DRAWING

1 spray drift reduction curtain surrounding spray booms
2 stainless steel spray booms
3 stainless steel solenoid valves
4 stainless steel ball valves
5 overflow return lines from individual spray booms to combination salt brine storage and mixing tank
6 bladder tank to regulate pumping system pressure
   Advantages.

My patent will reduce the labor needed, fuel costs, number of trucks required and rock salt used as one plow truck will be able to deice more lane miles with the heated brine solution as it is a highly saturated salt brine which will improve its melting power and will not be wasted from over spraying with the anti drift curtain installed around the spray booms.

The deicing unit will reduce saltwater pollution to a minimum as no salt will be wasted from spraying the salt water brine solution. due to the simple fact that the spray will stay on the road surface and do its work of melting the ice and snow left after plowing.

Operation

Plain water is pumped into the brine tank and salt blocks are added to the brine tank until the desired level of salinity is achieved. Additional products such as molasses and magnesium chloride and or calcium chloride may be added at the same time as well to enhance the salt brines ice and snow melting ability.

The diesel fueled electric generator is started to provide power to the low voltage pendant control in the truck cab, the hot water generator, and circulating pump to pump and thoroughly mix the deicing solution prior to use.

The brine solution is pumped through a stainless steel heat exchanger by an electric powered pump to heat the brine mixture, it is then either pumped back to the brine tank for additional mixing or to the spray booms.

The brine flow is regulated and directed by the stainless steel manually operated ball valves and stainless steel solenoid valves to the spray booms.

The solenoid valves are controlled by the pendant control in the truck cab.

Brine overflow is returned back to the brine tank by overflow return lines from both spray booms. Both overflow return lines have air gaps to prevent siphoning back into the spray booms

Utilizing off the shelf components for the deicing unit allows design simplicity and the easy repair and maintenance of the pumps and other equipment as they are readily obtainable with little or no delay and any repairs are accomplished quickly due to the inherent simplicity of the deicing units electrical system, plumbing and stainless steel construction and reduced need for parts inventory.

### CONCLUSION, RAMIFICATIONS, AND SCOPE

Accordingly the reader will see the advantages to the heated salt water deicing unit invention from the description of the its operation, reduction of rock salt used as a deicer and snow control product as pure evaporated salt is used and its simplicity of design and construction of the heated salt water deicing unit.

1. I claim a new use method for deicing streets highways using hot highly saturated salt brine with or with out molasses or magnesium chloride or calcium chloride as adjuncts for deiceing roads, streets, bridges and highways comprising:
(a) a large main brine storage tank with a combined use of salt block storage and hot brine mixing with or with out adjuncts such as molasses and magnesium chloride, said tank is also the feeder tank for the heated brine pumped to the spray booms for deicing the highway.
(b) a separate diesel storage fuel tank for the hot water generator and electrical generator.
(c) a 220 volt electrical generator.
(d) a low voltage pendant remote control for operation of the solenoid valves and brine circulating pump.
(e) a weatherproof electrical panel.
(f) a 220 volt multiple fuel fired hot water generator.
(g) a stainless steel water to water heat exchanger.
(h) a 220 volt hot water circulating pump
(i) a bladder tank to regulate system water pressure.
(j) a pressure control switch.
(k) a plurality of one half inch 304 stainless steel piping for brine pumping, mixing, spraying and recirculation of salt brine.
(l) a plurality of one half inch inside diameter standard pipe thread low voltage solenoid valves for controlling salt brine delivery to the spray boom.
(m) a plurality of one half inch inside diameter standard pipe thread stainless steel ball valves to divert, control and shut off flow to the pump, tank and spray boom or booms of the deicing unit.
(n) a plurality of one half inch pipe thread stainless steel jet spray nozzles to spray the heated concentrated salt brine mixture with or without adjuncts such as molasses or magnesium chloride on to the roadway requiring deicing and snow removal.
(o) a spray drift prevention curtain surrounding the spray booms consisting of either burlap or used conveyor belt to eliminate salt spray drift.
